(19) United States
(12) Patent Application Publication
(10) Pub. No.: US 2008/0199636 A1
(43) Pub. Date: Aug. 21, 2008

(54) Double-Sided Pressure-Sensitive Adhesive Tapes For Producing or Bonding Lc Displays With Light-Absorbing Properties

(75) Inventors: Marc Husemann, Hamburg (DE); Reinhard Storbeck, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/915,244

(22) PCT Filed: Dec. 2, 2005
(86) PCT No.: PCT/EP2005/056405

§ 371 Date: Mar. 25, 2008

(30) Foreign Application Priority Data
Jun. 13, 2005 (DE) 102005027391.2

(51) Int. Cl. B29C 65/50; C09J 7/02

(52) U.S. Cl. 428/1.5; 156/106; 156/306.6

(57) ABSTRACT

A pressure sensitive adhesive tape for producing or bonding optical liquid crystal data displays (LCD's) is disclosed. The pressure sensitive adhesive tape is constructed of an upper side and an underside, as well as a carrier film with an upper side and a lower side. At least one pressure sensitive adhesive layer is applied to both the upper and lower side of the adhesive tape. The adhesive tape also includes at least two black layers on one side of the carrier film between one of the outer pressure sensitive adhesives, and a silver-colored layer between the two black layers.

The invention relates to double-sided pressure-sensitive adhesive tapes having multilayer carrier constructions and having light-absorbing properties, for producing and/or for adhesively bonding liquid-crystal displays (LC displays, LCDs).

In the age of industrialization, pressure-sensitive adhesive (PSA) tapes are widespread processing auxiliaries. For use in the computer industry in particular, very exacting requirements are imposed on PSA tapes. As well as having a low outgassing behavior, the PSA tapes ought to be suitable for use across a wide temperature range and ought to fulfill defined optical properties.

One field of use is that of optical liquid-crystal displays (LC displays, LCDs), which are needed for computers, TVs, laptops, PDAs, cell phones, digital cameras, etc.

In this segment, it is very common around LC displays to use what are called spacer tapes, which possess light-absorbing functions. The intention on the one hand is to prevent light from outside entering the display. On the other hand the intention is that no light should reach the outside from the light source of the LC display.

Within this industry there is a trend toward more lightweight device units featuring higher resolution, and toward ever-larger LC displays. Associated with this trend, too, are stronger and increasingly more efficient light sources, which in turn are imposing more exacting requirements on the light-absorbing properties of the adhesive tape. For this application it is common to employ black double-sided adhesive tapes. For the production of these adhesive tapes and for the carriers they require there are numerous approaches in existence.

One proposed solution is the coloring of the PSA. In this case, for example, complete absorption of the light is achieved through addition of carbon black particles or black color pigments. This process is simple, but also has a variety of drawbacks. In the production operation, the carbon black particles or black color pigments must be stirred into the adhesive, a costly and inconvenient operation. As a result there is severe blackening (dirtying) of the production material, which must then be cleaned again, likewise at great cost and inconvenience, when conventional PSAs without coloring are to be processed. A further drawback is that the absorption of the light is influenced by the layer thickness of the adhesive. In the case of relatively thin adhesive layers in particular, there is a marked decrease in the absorption of the light. In the context of using LC displays, different layer thicknesses are entirely customary, since different manufacturers impose different requirements on the bond strengths. A further drawback of the approach of coloring the adhesive is that the addition of carbon black or color pigment alters the technical properties of the adhesive, which is likewise an unwanted phenomenon.

A second approach to producing black double-sided PSA tapes lies in the coloring of the carrier material. Within the electronics industry it is very much preferred to use double-sided PSA tapes having PET carriers, since these carriers can be diecut very effectively. The PET carriers can likewise be colored with carbon black or black color pigments in order to achieve absorption of the light.

The drawback of this existing approach is the low level of light absorption. In very thin carrier layers only a relatively small number of carbon black particles or other black pigment particles can be incorporated, with the consequence that light absorption is incomplete. With the eye and also with relatively intense light sources, such as a laser pointer, for example, the deficient absorption can then be ascertained.

A third approach to producing black double-sided PSA tapes concerns the production of a two-layer or three-layer carrier material by means of coextrusion. Carrier films are generally produced by extrusion. By means of coextrusion, as well as the conventional carrier material, a second and also, optionally, a third black layer is or are coextruded, fulfilling the function of light absorption. This approach too has a variety of drawbacks.

One problem is posed, for example, by the layer thicknesses, since the two or three layers are first of all shaped individually in the die and it is therefore possible overall to realize only relatively thick carrier layers, with the result that the film becomes relatively thick and inflexible and hence its conformation to the surfaces to be bonded is poor. Moreover, the black layer must likewise be relatively thick, since otherwise complete absorption cannot be realized. A further drawback lies in the altered mechanical properties of the carrier material, since at least one black layer is coextruded whose mechanical properties are different from those of the original carrier material (e.g., PET). A further drawback for the two-layer version of the carrier material is the difference in anchoring of the adhesive on the coextruded carrier material. For this embodiment there is always a weak point in the double-sided adhesive tape.

In a fourth approach, films are metalized and then painted black subsequently. This process yields very good results in respect of light absorption properties, but is relatively costly and inconvenient to implement, since the metalization and coating must be undertaken in different operations.

Additionally there is a reduction in the dimensional stability of the film, since metal and polymer film possess different coefficients of expansion and hence in the production process of the adhesive tape, for example, under temperature exposure, the film curls at the edge and the flat lie of the completed adhesive tape is deficient.

JP 2002-235053 describes double-sided adhesive tapes for LCD applications that are based on black-colored material. The drawbacks associated with this have already been described above.

JP 2002-350612 describes double-sided adhesive tapes for LCD panels with light-protective properties. The function is achieved by means of a metal layer applied on one or both sides to the carrier film, it also being possible, additionally, for the carrier film to have been colored. The metalization makes the production of the adhesive tape relatively costly and inconvenient, and the flat lie of the adhesive tape itself is deficient.

JP 2002-023663 likewise describes double-sided adhesive tapes for LCD panels that have light-protective properties. Here again, the function is achieved by means of a metal layer applied on one or both sides to the carrier film. The patent additionally embraces colored adhesives. The problems associated with this have already been discussed.

For the adhesive bonding of LCD displays and for their production, therefore, there is a need for double-sided PSA tapes which do not have the deficiencies described above, or which have them only to a reduced extent.

It is an object of the invention, therefore, to provide a double-sided PSA tape which possesses high light absorbency, which can be realized with a carrier even with layer thicknesses below 20 μm, in order to achieve optimum technical properties, and in which the carrier possesses a high dimensional stability under temperature exposure.

This object is achieved by means of pressure-sensitive adhesive tapes of the kind set out in the main claim. The dependent claims relate to advantageous embodiments of the pressure-sensitive adhesive tapes of the invention, and also to their use.

The main claim accordingly provides a pressure-sensitive adhesive tape, in particular for the production or adhesive bonding of optical liquid-crystal displays (LCDs), comprising a top side and a bottom side, further comprising a carrier film having a top side and a bottom side, the pressure-sensitive adhesive tape being furnished both on its top side and on its bottom side with at least one external pressure-sensitive adhesive layer in each case, wherein additionally provided at least on one side of the film, between the outer pressure-sensitive adhesive layer and the carrier film, are at least two black layers between which there is at least one silver (i.e., silver-colored) layer.

This arrangement of two black layers with at least one silver layer provided in between them is also referred to below as a three-layer arrangement.

In one advantageous procedure there are three-layer arrangements provided on both sides of the carrier film.

In one advantageous embodiment of the invention at least one of the two outer pressure-sensitive adhesive layers is transparent, more particularly the layer on the side of the pressure-sensitive adhesive tape on which the three-layer arrangement is provided.

Advantageously it is possible for both outer pressure-sensitive adhesive layers to be of transparent design, also, with particular advantage, in those cases where three-layer arrangements are provided on both sides of the carrier film.

The pressure-sensitive adhesive layers (d) and (d′) on the two sides of the PSA tape of the invention may in each case be identical or different, particularly with regard to their embodiment (layer thickness and the like) and their chemical composition. With particular preference the PSA at least on the side of the PSA tape is transparent, and preferably on the side—as viewed from the carrier film—on which the black-silver-black three-layer arrangement is provided. In the inventive sense, however, it may also be advantageous to implement transparent PSAs on both sides of the PSA tape.

With great preference one or more of the black layers is or are paint layers.

In preferred embodiments of the invention there are further black layers provided in the adhesive tape.

Set out below are some advantageous embodiments of the adhesive tape of the invention, without wishing the choice of the examples to impose any unnecessary restriction on the invention.

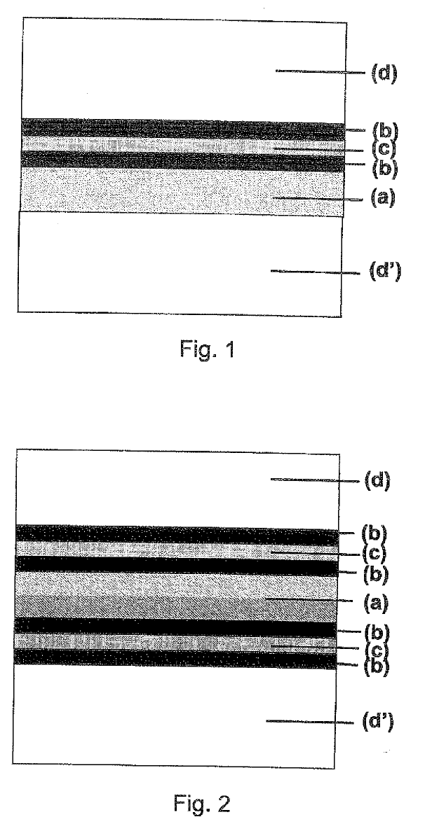

In a first advantageous embodiment of the invention, as depicted in FIG. 1, the inventive pressure-sensitive adhesive tape is composed of a carrier film layer (a), a multilayer paint system composed of at least two black color layers (b) and also of a silver (i.e., silver-colored) and nontransparent color layer (c), and two pressure-sensitive adhesive layers (d) and (d′).

In a further preferred embodiment of the invention the inventive pressure-sensitive adhesive tape possesses the product construction depicted in FIG. 2. In this case the double-sided pressure-sensitive adhesive tape is composed of a carrier film (a), at least four black paint layers (b), at least two silver and nontransparent color layers (c), each enclosed by two of the black layers, and two pressure-sensitive adhesive layers (d) and (d′). Advantageously it is possible here for both PSA layers (d) and (d′) to be transparent.

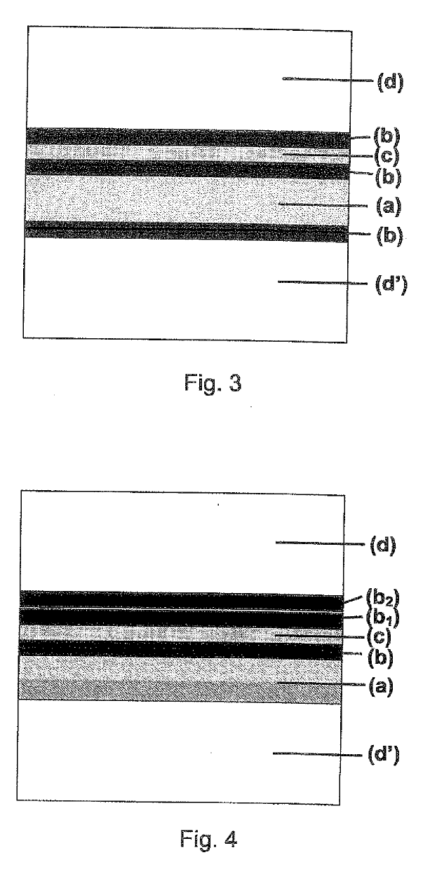

In a third preferred embodiment of the invention the inventive pressure-sensitive adhesive tape possesses the product construction according to FIG. 3. In this case the double-sided pressure-sensitive adhesive tape is composed of a carrier film (a), at least three black paint layers (b), at least one silver and nontransparent color layer (c), two pressure-sensitive adhesive layers (d) and (d′), the PSAs possibly being identical or differing from one another. On the reverse side of the carrier (as seen from the three-layer arrangement) there is provided in this case, on the basis of the variant embodiment in FIG. 1, a further black layer.

In a further preferred embodiment of the invention, depicted by way of example in FIG. 4, the double-sided pressure-sensitive adhesive tape is composed of a carrier film (a), at least three black paint layers (b), (b₁), (b₂), with at least two paint layers (b₁), (b₂) being painted one over the other [the indices 1 and 2 serve in the case of two identical paint layers essentially to distinguish between the layers in terms of language and graphically; however, there may also be two black paint layers of different kinds provided], at least one silver and nontransparent color layer (c), and two pressure-sensitive adhesive layers (d) and (d′), the PSAs possibly being identical or differing from one another. In the example depicted, the dual paint layer lies on the side of the silver layer that is facing away from the carrier, while in this case there is a single paint layer provided on the side nearer the carrier.

For a variant of this embodiment, the dual paint layer can also be provided on the side nearer to the carrier, as seen from the silver layer. On the side facing away from the carrier it is possible in that case to provide one or, again, two paint layers.

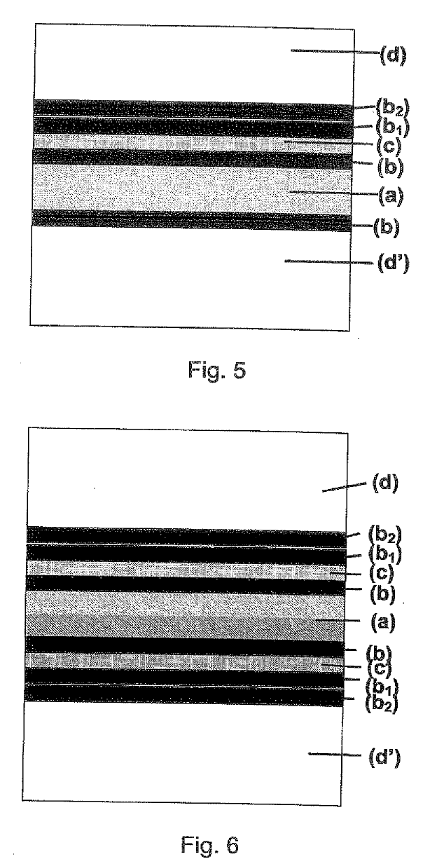

In a further preferred embodiment of the invention (in this regard see FIG. 5) the double-sided pressure-sensitive adhesive tape is composed of a carrier film (a), at least four black paint layers (b), where at least two paint layers (b₁), (b₂) in each case are painted one above the other, at least one silver and nontransparent color layer (c), and where the carrier film is provided on both sides with at least in each case one black color layer (b), and two pressure-sensitive adhesive layers (d) and (d′).

In a further preferred embodiment of the invention, depicted in FIG. 6, the double-sided pressure-sensitive adhesive tape is composed of a carrier film (a), at least six black paint layers (b), there being at least in each case two paint layers (b₁), (b₂) coated one above another on both sides of the carrier film (a), at least two silver and nontransparent color layers (c) on each side of the carrier film (a), the carrier film is painted black at least on both sides with a color layer (b) and two pressure-sensitive adhesive layers (d) and (d′), it being possible for the PSAs to be identical or to differ from one another.

The invention is explained in more detail in the text below:

All of the limit values stated are to be understood as inclusive values, i.e., as values contained within the stated limit range.

The carrier film (a) is preferably between 5 and 100 μm, more preferably between 8 and 50 μm, most preferably between 12 and 23 μm thick, and very preferably is transparent or semitransparent or opaque.

With advantage the coloring layers can be applied directly to the carrier film and/or to the color layers which have already been coated onto said film. The layers (b) are black and light-absorbing. The coat weight of the black paint per layer is preferably between 0.5 and 3 g/m². The layer (c) is silver-colored and opaque. The coat weight of the silver paint is advantageously between 0.5 and 3 g/m². The PSA layers (d) and (d′) preferably possess a thickness of in each case between 5 μm and 250 μm. The individual layers (b), (c), (d), and (d′) may differ in thickness within the double-sided pressure-sensitive adhesive tape, so that it is possible, for example, to apply PSA layers of different thickness, or else to select certain layers, two or more layers, or else all the layers identically.

Carrier Film (a)

As film carriers it is possible in principle to use all film-type polymer carriers, more particularly those which are transparent, semitransparent or opaque. Thus, for example, polyethylene, polypropylene, polyimide, polyester, polyamide, polymethacrylate, fluorinated polymer films, etc., can be used. One particularly preferred embodiment uses polyester films, with particular preference PET (polyethylene terephthalate) films. The films may be in detensioned form or may have one or more preferential directions. Preferential directions are achieved by stretching in one or two directions.

Particular preference is given to using PET films 12 μm thick, or thinner films. 12 μm PET films allow very good technical properties for the double-sided adhesive tape, since in that case the film is very flexible and is able to conform well to the surface roughnesses of the substrates that are to be bonded.

To improve the anchoring of the paint layers it is very advantageous if the films are pretreated. The films may be etched (using trichloroacetic or trifluoroacetic acid, for example), corona- or plasma-pretreated, or furnished with a primer (e.g., Saran). Optionally the primer as well may also be colored, in order to enhance the light-absorbing properties.

Furthermore, it is possible with advantage—especially if the film material is transparent or semitransparent—to add color pigments or chromophoric particles to the film material. Hence, for example, carbon black is suitable for black coloring, and titanium dioxide particles for white coloring. This coloring produces a further reduction in the light transmittance. The pigments or particles ought preferably, however, to be smaller in diameter than the final layer thickness of the carrier film. Optimum colorations can be achieved with 10% to 40% by weight particle fractions, based on the film material.

Color Layers (b), (b₁), (b₂)

The color layers (b), (b₁), and (b₂) fulfill the function of the black coloring of at least one side of the adhesive tape. For the absorption of light in the LC display it is advantageous for the double-sided pressure-sensitive adhesive tape to possess a transmittance of <1% within a wavelength range of 300-800 nm.

In the context of this invention the black paint layers make a contribution to this. In a curing binder matrix (preferably a thermosetting system, although a radiation-curing system is also possible), black color pigments are mixed into the paint matrix. Paint materials used may be, for example, polyesters, polyurethanes, polyacrylates or polymethacrylates, more particularly in conjunction with the paint additives known to the skilled worker. In one inventive embodiment which is very much to be preferred, carbon black or graphite particles are mixed as chromophoric particles into the binder matrix. At a very high level of additization (>20% by weight), this additization produces not only the substantially complete light absorption but also electrical conductivity, so that the inventive double-sided PSA tapes likewise feature antistatic properties.

Color Layers (c)

The color layer (c) fulfills the function of a layer for reducing the light transmittance. The layer(s) (c) hence also contribute(s) to reducing the absorption of light in the LC display of the double-sided PSA tape, it being particularly advantageous to reduce the transmittance to <1% within a wavelength range of 300-800 nm.

In a curing binder matrix (preferably a thermosetting system, although a radiation-curing system is also possible), silver (especially silver-metallic and/or silver-colored) color pigments are mixed into the paint matrix. Paint materials used may be, for example, polyesters, polyurethanes, polyacrylates or polymethacrylates, more particularly in conjunction with the paint additives known to the skilled worker. In one inventive embodiment which is very much to be preferred, metal particles are mixed as silver chromophoric pigments into the binder matrix. At a very high level of additization (>20% by weight), this additization produces not only the substantially complete light absorption but also electrical conductivity, so that the inventive double-sided PSA tapes likewise feature antistatic properties.

Pressure-Sensitive Adhesives (PSAs) (d) and (d′)

The PSAs (d) and (d′) are, in one preferred embodiment, identical on both sides of the PSA tape. In one specific embodiment, however, it may also be of advantage for the PSAs (d) and (d′) to differ from one another, in terms for example of their layer thickness and/or their chemical composition. Hence in this way it is possible, for example, to set different pressure-sensitive adhesion properties. PSA systems used in particular for the inventive double-sided PSA tape are acrylate, natural-rubber, synthetic-rubber, silicone or EVA adhesives.

It is also possible, furthermore, to process the further PSAs that are known to the skilled worker; in this regard compare, for example, the “Handbook of Pressure Sensitive Adhesive Technology” by Donatas Satas (van Nostrand, New York 1989) for the depiction of the state of the art.

For natural-rubber adhesives the natural rubber is preferably milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV types, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is preferably made of (meth)acrylate PSAs.

(Meth)acrylate PSAs employed in accordance with the invention, which are obtainable by free-radical addition polymerization, advantageously consist to the extent of at least 50% by weight of at least one acrylic monomer from the group of the compounds of the following general formula:

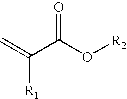

In this formula the radical R₁═H or CH₃ and the radical R₂═H or CH₃ or is selected from the group containing the branched and unbranched, saturated alkyl groups having 1-30 carbon atoms.

The monomers are preferably chosen such that the resulting polymers can be used, at room temperature or higher temperatures, as PSAs, particularly such that the resulting polymers possess pressure-sensitive adhesive properties in accordance with the “Handbook of Pressure Sensitive Adhesive Technology” by Donatas Satas (van Nostrand, New York 1989).

In a further inventive embodiment the (co)monomer composition is chosen such that the PSAs can be used as heat-activable PSAs.

The polymers can be obtained preferably by polymerizing a monomer mixture which is composed of acrylic esters and/or methacrylic esters and/or the free acids thereof, with the formula CH₂═CH(R₁)(COOR₂), where R₁═H or CH₃ and R₂ is an alkyl chain having 1-20 carbon atoms or is H.

The molar masses M_{w} (weight average) of the polyacrylates used amount preferably to M_{w}≧2 200 000 g/mol.

In one way which is greatly preferred, acrylic or methacrylic monomers are used which are composed of acrylic and methacrylic esters having alkyl groups comprising 4 to 14 carbon atoms, and preferably comprise 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 carbon atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In an advantageous procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethylmethacrylamide, N-tert-butylacryl-amide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropylacrylamide, this enumeration not being intended as exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being intended as exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in a further procedure, use is made of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized by a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

As a result of the increase in the aromatic fraction there is a rise in the refractive index of the PSA.

For further development it is possible to admix resins to the PSAs. As tackifying resins for addition it is possible to use the tackifier resins previously known, and described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Reference is expressly made to the presentation of the state of knowledge in the “Handbook of Pressure Sensitive Adhesive Technology” by Donatas Satas (van Nostrand, 1989). Here as well, the transparency is improved using, preferably, transparent resins which are highly compatible with the polymer. Hydrogenated or partly hydrogenated resins frequently feature these properties.

In addition it is possible optionally to add plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers.

In a further embodiment of the invention the PSA (d) and (d′) comprises light-absorbing particles, such as black color pigments or carbon-black particles or graphite particles, for example, as a filler.

In addition it is possible to admix crosslinkers and promoters for crosslinking. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

Preparation Process for the acrylate PSAs

For the polymerization the monomers are advantageously chosen such that the resulting polymers can be used at room temperature or higher temperatures as PSAs, in particular such that the resulting polymers possess pressure-sensitive adhesive properties in accordance with the “Handbook of Pressure Sensitive Adhesive Technology” by Donatas Satas (van Nostrand, New York 1989).

In order to achieve a preferred polymer glass transition temperature T_{g} of ≦25° C. for PSAs it is very preferred, in accordance with the comments made above, to select the monomers in such a way, and choose the quantitative composition of the monomer mixture advantageously in such a way, as to result in the desired T_{g} for the polymer in accordance with equation (E1) analogous to the Fox equation (cf. T.G. Fox, Bull. Am. Phys. Soc. 1 (1956) 123).

$$\frac{1}{{T}_{g}} = {\sum }_{n} \frac{{w}_{n}}{{T}_{g , n}} \qquad ( E1 )$$

In this equation, n represents the serial number of the monomers used, wₙ the mass fraction of the respective monomer n (% by weight), and T_{g,n} the respective glass transition temperature of the homopolymer of the respective monomers n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free-radical initiator used is 1,1′-azobis(cyclohexane-carbonitrile) (Vazo 88™ from DuPont) or azoisobutyronitrile (AIBN).

The average molecular weights M_{w} of the PSAs formed in the free-radical polymerization are very preferably chosen such that they are situated within a range of 200 000 to 4 000 000 g/mol; specifically for further use as electrically conductive hotmelt PSAs with resilience, PSAs are prepared which have average molecular weights M_{w} of 400 000 to 1 400 000 g/mol. The average molecular weight is determined by size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water.

The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

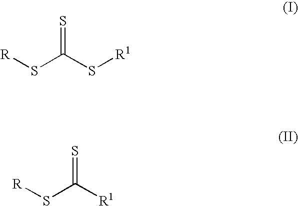

in which R and R¹ are chosen independently of one another or are identical, and
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following compounds: halogen atoms therein are preferably F, Cl, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl radicals having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

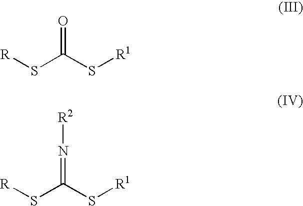

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hotmelt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

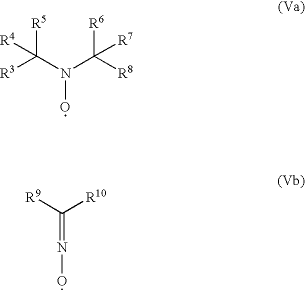

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of type (Va) or (Vb) can also be attached to polymer chains of any kind (primarily such that at least one of the abovementioned radicals constitutes a polymer chain of this kind) and may therefore be used for the synthesis of polyacrylate PSAs. With greater preference, controlled regulators for the polymerization of compounds of the following types are used:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates.

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

Coating Process, Treatment of the Carrier Material

For preparation, in one preferred embodiment the pressure-sensitive adhesive is coated from solution onto the carrier material. To increase the anchoring of the PSA it is possible optionally to pretreat the layers (b) and/or (c). Thus pretreatment may be carried out, for example, by corona or by plasma, a primer can be applied from the melt or from solution, or etching may take place chemically.

Particularly in the case of the black paint layer, however, the corona output ought to be minimized, since otherwise pinholes are burnt into the film. For the coating of the PSA from solution, heat is supplied, in a drying tunnel for example, to remove the solvent and, if appropriate, initiate the crosslinking reaction.

The polymers described above can also be coated, furthermore, as hotmelt systems (i.e., from the melt). For the preparation process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%. Further processing of the hotmelt takes place from the melt.

For coating as a hotmelt it is possible to employ different coating processes. In one version the PSAs are coated by a roll coating process. Different roll coating processes are described in the “Handbook of Pressure Sensitive Adhesive Technology”, by Donatas Satas (van Nostrand, New York 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels. Through the coating it is also possible for the PSAs to undergo orientation.

In addition it may be necessary for the PSA to be crosslinked. In one preferred version, crosslinking takes place with actinic radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one advantageous embodiment of the invention the PSAs are crosslinked using electron beams. Typical irradiation equipment which can be advantageously employed includes linear cathode systems, scanner systems, and segmented cathode systems, where electron beam accelerators are employed. A detailed description of the state of the art and the most important process parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 and 150 kGy, in particular between 20 and 100 kGy.

It is also possible to employ both crosslinking processes, or other processes allowing high-energy irradiation.

The invention further provides for the use of the inventive double-sided pressure-sensitive adhesive tapes for adhesive bonding or production of LC displays. For use as pressure-sensitive adhesive tape it is possible for the double-sided pressure-sensitive adhesive tapes to have been lined with one or two release films or release papers. In one preferred embodiment, use is made of siliconized or fluorinated films or papers, such as glassine, HDPE or LDPE coated papers, for example, which have in turn been given a release coat based on silicones or fluorinated polymers.

With particular advantage the PSA tapes of the invention are suitable for adhesively bonding light-emitting diodes (LEDs) as a light source with the LCD module.

### EXAMPLES

The invention is described below, without wishing any unnecessary restriction to result from the choice of the examples.

The following test methods were employed.

Test Methods

A. Transmittance

The transmittance was measured in the wavelength range from 190 to 900 nm using a Uvikon 923 from Biotek Kontron on a sample film 100 μm thick, applied to 50 μm polyolefin film, with measurement taking place against an uncoated polyolefin film reference. The measurement is conducted at 23° C. The absolute transmittance is reported as the value at 550 nm in % relative to complete light absorption (transmittance 0%=no light transmission; transmittance 100%=complete light transmission).

B. Laser Pointer Test

Using a commercial laser pointer (laser diode class II, wavelength 650 nm, laser power 0.6 mW, Conrad Laser Pointer LP 6 Mini) a beam is shone vertically from a distance of 5 cm onto a sample of the double-sided PSA tape of the invention. An assessment is made, from the other side of the PSA tape, of whether the laser light penetrates the PSA tape or not, by observing whether the laser beam breaks out or does not break out on this side on a white sheet of paper located at a distance of 5 cm from, and parallel to, the PSA tape.

A pass is scored in the test if there is no visual indication that the laser light is able to penetrate the adhesive tape—in other words, if no spot of light can be detected on the 20 paper.

Polymer 1

A 200 l reactor conventional for free-radical polymerizations was charged with 2400 g of acrylic acid, 64 kg of 2-ethylhexyl acrylate, 6.4 kg of N-isopropylacrylamide and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature.

After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture was cooled to room temperature.

Polymer 2

A 200 l reactor conventional for free-radical polymerizations was charged with 1200 g of acrylic acid, 74 kg of 2-ethylhexyl acrylate, 4.8 kg of N-isopropylacrylamide and 53.3 kg of acetone/isopropanol (95:5). After nitrogen gas had been passed through the reactor for 45 minutes with stirring, the reactor was heated to 58° C. and 40 g of 5,2,2′-azoisobutyronitrile (AIBN) were added. Subsequently the external heating bath was heated to 75° C. and the reaction was carried out constantly at this external temperature. After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture was cooled to room temperature.

Crosslinking

The PSAs were coated from solution onto a siliconized release paper (PE-coated release paper from Loparex), dried in a drying cabinet at 100° C. for 10 minutes, and then crosslinked with a dose of 25 kGy of electron beams at an acceleration voltage of 200 kV. The coatweight was in each case 50 g/m².

Film (Color Coating):

A 12 μm PET film is coated using the roll printing process. The respective color layers are applied in different steps. The operation of applying the different color layers (b) and (c) takes place preferably in one operation.

The coatweight per paint layer was approximately 1.2 g/m².

The process described was used to produce the films sketched in FIGS. 5 and 6 (designation below: film according to FIG. 5=film 5, film according to FIG. 6=film 6).

### Example 1

Film 5 is coated with polymer 1 by a laminating process on both sides at 50 g/m².

### Example 2

Film 5 is coated with polymer 2 by a laminating process on both sides at 50 g/m².

Example 3

Film 6 is coated with polymer 1 by a laminating process on both sides at 50 g/m².

### Example 4

Film 6 is coated with polymer 2 by a laminating process on both sides at 50 g/m².

Results

Additionally, tests B and C were carried out with examples 1 to 4 and with reference example 1. The results are set out in table 1.

TABLE 1

| | Transmittance | Laser pointer |
|---|---|---|
| Example | (test B) | (test C) |
| 1 | <1% | pass |
| 2 | <1% | pass |
| 3 | <1% | pass |
| 4 | <1% | pass |

From the results from table 1 it is apparent that examples 1 to 4 fulfill the light-absorbing function very well, and completely absorb the light.

To examine the technical adhesive capacity, examples 1 to 4 were also trialed in applications-related bonds. All of the examples, therefore, were used to bond LCD panels to backlight units. No transmission of light through the tape was observed.

1. A pressure-sensitive adhesive tape for the production or adhesive bonding of optical liquid-crystal displays (LCDs), comprising a top side and a bottom side, a carrier film having a carrier film top side and a carrier film bottom side, and at least one external pressure-sensitive adhesive layer furnished on both the top and bottom side of the adhesive tape, wherein, at least two black layers between which there is at least one silver (i.e., silver-colored) layer are provided on at least one side of the film between at least one of the outer pressure sensitive adhesive layers and the carrier film.

2. The pressure-sensitive adhesive tape of claim 1 wherein at least one of the two outer pressure-sensitive adhesive layers is transparent,

3. The pressure-sensitive adhesive tape of claim 1, wherein one or both black layers are paint layers.

4. The pressure-sensitive adhesive tape of wherein three or more black layers are provided in the adhesive tape.

5. The pressure-sensitive adhesive tape of wherein the carrier film has a thickness between 5 and 100 μm,

6. The pressure-sensitive adhesive tape of claim 1 wherein the areal mass of one or more of the black layers is between 0.5 and 3 g/m².

7. The pressure-sensitive adhesive tape of claim 1 wherein the areal mass of the at least one silver layer is between 0.5 and 3 g/m².

8. The pressure-sensitive adhesive tape of claim 1 wherein the silver color of the silver layer is produced by metal particles.

9. The pressure-sensitive adhesive tape of claim 1 wherein a layer sequence is comprised as follows: pressure-sensitive adhesive (layer d)—black paint layer (layer b)—silver layer (layer c)—black paint layer (layer b)—carrier film (layer a)—pressure-sensitive adhesive (layer d′).

10. The pressure-sensitive adhesive tape of claim 4 wherein a layer sequence is comprised as follows: pressure-sensitive adhesive (layer d)—black paint layer (layer b)—silver layer (layer c)—black paint layer (layer b)—carrier film (layer a)—black paint layer (layer b)—silver layer (layer c)—black paint layer (layer b)—pressure-sensitive adhesive (layer d′).

11. The pressure-sensitive adhesive tape of claim 4 wherein a layer sequence is comprised as follows: pressure-sensitive adhesive (layer d)—black paint layer (layer b)—silver layer (layer c)—black paint layer (layer b)—carrier film (layer a)—black paint layer (layer b)—pressure-sensitive adhesive (layer d′).

12. The pressure-sensitive adhesive tape of claim 4 wherein a layer sequence is comprised as follows: pressure-sensitive adhesive (layer d)—second black paint layer (layer b₂)—first black paint layer (layer b₁)—silver layer (layer c)—black paint layer (layer b)—carrier film (layer a)—pressure-sensitive adhesive (layer d′).

13. The pressure-sensitive adhesive tape claim 4 wherein a layer sequence is comprised as follows: pressure-sensitive adhesive (layer d)—second black paint layer (layer b₂)—first black paint layer (layer b₁)—silver layer (layer c)—black paint layer (layer b)—carrier film (layer a)—black paint layer (layer b)—pressure-sensitive adhesive (layer d′).

14. The pressure-sensitive adhesive tape of claim 4 wherein a layer sequence is comprised as follows: pressure-sensitive adhesive (layer d)—second black paint layer (layer b₂)—first black paint layer (layer b₁)—silver layer (layer c)—black paint layer (layer b)—carrier film (layer a)—black paint layer (layer b)—silver layer (layer c)—first black paint layer (layer b₁)—second black paint layer (layer b₂)—pressure-sensitive adhesive (layer d′).

15. A method for producing or adhesively bonding an optical liquid-crystal display comprising adhering a pressure sensitive tape according to claim 1 to an optical liquid-crystal display.

16. The method of claim 15 wherein the pressure sensitive adhesive tape is used for adhesively bonding LCD glasses.

17. A liquid-crystal display device comprising a pressure-sensitive adhesive tape of claim 1.

18. The pressure sensitive adhesive tape of claim 2 wherein the transparent pressure sensitive adhesive layer is the layer on the side of the pressure sensitive adhesive tape on which the two black layers with the silver layer in between are located.

19. The pressure sensitive adhesive tape of claim 5 wherein the carrier film has a thickness of between about 8 and 50 μm.

20. The pressure sensitive adhesive tape of claim 19 wherein the carrier film has a thickness of about 12 μm.
